(19) United States
(12) Patent Application Publication
(10) Pub. No.: US 2003/0224840 A1
(43) Pub. Date: Dec. 4, 2003

(54) Communications device of a motor vehicle and method for setting up a call diversion

(76) Inventors: Bernard Frank, Markt Schwaben (DE); Dietrich Gabler, Seligenstadt (DE); Ronald Hain, Oberasbach (DE); Bernhard Klein, Pettendorf (DE); Wolfgang Scheidl, Bernhardswald (DE); Rainer Tilgner, Remseck (DE)

Correspondence Address: Bruce W. Slayden II, Baker Botts L.L.P., 910 Louisiana Street, Houston, TX, 77002-4995, US

(21) Appl. No.: 10/386,965

(22) Filed: Mar. 12, 2003

Related U.S. Application Data
(63) Continuation of application No. PCT/DE01/03131, filed on Aug. 16, 2001.

(30) Foreign Application Priority Data
Sep. 12, 2000 (DE) 10045303.1

(51) Int. Cl. H04Q 7/20

(52) U.S. Cl. 455/575.9; 455/41.2

(57) ABSTRACT

A communications system of a motor vehicle is disclosed in which a communications device (101) for setting up a mobile radio link is installed in the motor vehicle, which mobile radio link also has a short-range radio device. An external mobile radio device (118; 119) also additionally has such a short-range radio device. If the mobile radio device (118; 119) enters the radio range of the short-range radio device of the communications device (101) in the vehicle, data is exchanged between the devices over the short-range radio link. A comparator module in the communications device of the vehicle compares the received data with stored data with respect to specific features which contain an identifier of the mobile radio device (118; 119). If an authorized mobile radio device (118; 119) is detected, a call diversion is activated automatically within the cellular mobile phone network. Furthermore, a corresponding communications device (101) and a method for operating the communications system are proposed.

### Cross Reference to Related Application

This application is a continuation of copending International Application No. PCT/DE01/03131 filed Aug. 16, 2001, which designates the United States.

### BACKGROUND OF THE INVENTION

The invention relates to a communications device of a motor vehicle having an input unit and an audio output unit which are connected to a control unit, and a mobile radio module, connected to the control unit, of a cellular mobile radio system. Furthermore, the invention relates to a communications system having a communications device which is integrated in a vehicle, and an external mobile radio device of a cellular mobile radio system. Furthermore, the invention relates to a method for setting up an interactive call diversion between a first and a second mobile radio device of a cellular mobile radio system.

In the past, the classic car telephone was often predominantly used as the communications device in a motor vehicle. In the present case the communications device is a mobile radio device which is permanently installed in the vehicle and which can be operated either by means of a hand-held device or a hands-free device. It is also already known to integrate such a car telephone into an audio device of a motor vehicle. Such a device then contains, for example, a classic radio device, a CD player and the car radio, the entire device not exceeding the size of a conventional car radio and being capable of being installed in the DIN shaft present in vehicles. With such an embodiment, the loudspeakers of the audio device are also used for outputting the calls. A hands-free function is implemented by means of a microphone which is additionally integrated in the device. A disadvantage of such a system is that it can only be used within the vehicle, and the driver can only be reached within the vehicle, on a special telephone number. In addition, the comparatively high costs for a telephone whose range of use is restricted to the car are disadvantageous.

Furthermore, what are referred to as telematics systems are known, such as the ADAC-Telematik Service-Kit (ADAC Telematics Service Kit) described in auto, motor, sport 7/1999, pp. 140-142. Said kit contains a telematics control unit with an operator control part and a GPS receiver for precisely determining the position of the vehicle by evaluating satellite navigation signals. The telematics control unit is connected to a separate mobile radio device. Emergency and breakdown assistance functions are therefore available via the mobile radio link. In addition, traffic information can be received. The integrated hands-free device also permits use while travelling.

The unprepublished German patent application 1999 21 533.2 by the applicant discloses a communications system of a motor vehicle which is composed of a car radio and a mobile radio device. A short-range radio device, via which a link can automatically be set up between the car radio and the mobile radio device is integrated both into the car radio and into the mobile radio device, the car radio performing the function of a hands-free device for the mobile radio device. Both in this system and in the previously described telematics system it is disadvantageous that vehicle-specific functions such as, for example, an emergency call or the requesting of breakdown assistance or traffic information is possible only if an external mobile radio device is also brought into the vehicle.

### SUMMARY OF THE INVENTION

A first object of the invention comprises specifying a communications device of a motor vehicle which can also be used together with one or more external mobile radio devices, in particular as a hands-free device and in doing so permits user-specific billing, in particular when a vehicle is used by different users, but at the same time permits certain functions which are associated with the operation of a vehicle. A further object of the invention comprises specifying a communications system of a motor vehicle which contains a communications device which is integrated into a motor vehicle as an external mobile radio device and has the abovementioned functionality. A third object of the invention comprises specifying a method for setting up an interactive call diversion between a first and a second mobile radio device of a cellular mobile radio system which is suitable in particular for use in the abovementioned communications system.

The first-mentioned object can be achieved in a communications device of the generic type in that the communications device has a short-range radio device which is connected to the control unit, the short-range radio device being configured for the exchange of data over a short-range radio link, the communications device having a comparator module for comparing data received over the short-range radio link with data stored in a storage element and it being possible to automatically set up a mobile radio link for transferring a status message within the mobile radio system when received and stored data correspond with respect to predefined features.

The second object can be achieved by means of a communications system having a communications device which is integrated in a motor vehicle and has an input unit and an audio output unit which are connected to a control unit, and a mobile radio module, connected to the control unit, of a cellular mobile radio system, and a short-range radio device which is connected to the control unit, and an external mobile radio device of a cellular mobile radio system with a second short-range radio device, the short-range radio devices being configured to exchange data over a short-range radio link, the communications device having a comparator module for comparing data received from the mobile radio device over the short-range radio link with data stored in a storage element of the communications device, and it being possible to automatically set up a mobile radio link for transferring a status message within the mobile radio system when received and stored date correspond in terms of predefined features. The status message relates in particular to a call diversion within the mobile radio system.

The communications system according to the invention is thus composed of two components, namely firstly the inventive communications device of the motor vehicle and secondly an external mobile radio device, said device being in particular a mobile telephone (mobile). The communications device in the motor vehicle already contains a mobile radio module of a cellular mobile radio system and an input unit and an audio output unit. By virtue of these components, the communications device is already equipped for mobile radio links, and is thus also suitable in particular for the transmission of an emergency call or the requesting of breakdown assistance or traffic information. The corresponding components are known per se and correspond to the components used in the systems mentioned at the beginning.

Furthermore, the communications device has a short-range radio device which is connected to the control unit of the communications device. A long-range radio link can thus be set up via the mobile radio module of the cellular mobile radio system, while the short-range radio device can be used to set up a radio link to an external device over a comparatively short distance of typically less than 100 m, preferably less than 10 m. The external mobile radio device also has such a short-range radio device.

As soon as the external mobile radio device enters the radio range of the short-range radio device of the communications device, data can then be automatically exchanged between the external mobile radio device and the communications device in the vehicle. The communications device in the vehicle also has a comparator module for comparing the data received from the mobile radio device over the short-range radio link with data stored in a storage element. The comparator module is preferably configured here as a computer program which runs in the control unit. By means of the comparison which is provided, it is possible to test whether the external mobile radio device is an authorized device. If correspondence in terms of predefined features is detected between the received and the stored data during the comparison, a mobile radio link for transferring a status message is automatically set up within the mobile radio system.

Automatically setting up a mobile radio link is understood to mean not only completely automatically setting up without the intervention of the user but also in particular a method in which a user must first agree to the setting up of this mobile radio link or activate the setting up operation, but otherwise the link is set up automatically.

The advantage of the communications device according to the invention or of the communications system according to the invention is therefore firstly that the driver can be reached on the telephone number of his portable mobile radio device while driving in the vehicle, but at the same time he has the functionality of the communications device installed in the vehicle, in particular a hands-free function. There may also particularly be provision that only vehicle-related services, such as in particular emergency calls and breakdown calls or traffic information, is available via the communications device of the vehicle and the subscriber identification module (SIM card) which is required for it in the vehicle. On the other hand, driver-related services, such as an Internet access or other telephone calls (distinguished by means of the dialed number) are in this case made possible by means of the subscriber identification module (SIM card) of the external mobile radio device, but the driver can simultaneously use the functionality of the communications device installed in the vehicle for this purpose. It is thus possible for the components of the communications device, such as in particular hands-free device, input unit or the mobile radio antenna, to be used also for these driver-related services in order to improve the transmission quality, security and reliability during communication within the cellular mobile radio system.

The communications device can be, in particular, a component of an audio system, of a multimedia system, of a telematics system or of a navigation system. As a result, components of these systems can also be used. In the case of a combination with an audio system, in particular the loudspeakers of the audio system may be used as audio output unit. In combination with a multimedia system, it is also possible to use its loudspeakers as audio output unit and also its input unit. As a component of a telematics system, the communications device is also connected in particular to a GPS receiver device. Such systems are known per se and are described at the beginning. When the communications device is linked to a navigation system, it is possible in particular for traffic information which is received via the mobile phone network to be taken into account in the route calculation.

The cellular mobile radio system can be in particular a system according to the GSM or UMTS standard. This ensures that the communications device can be operated with wide area coverage and can be combined without difficulty with a multiplicity of external mobile radio devices.

A range of the short-range radio link of not more than 10 m is sufficient for the connection setup between the communications device and the external mobile radio device. A range of the short-range radio link which is adapted to the conditions in the vehicle ensures that the communications device is not continuously confronted with non-authorized mobile radio devices outside the vehicle, for example of pedestrians or of other car drivers. A short-range radio device which operates according to what is referred to as the Bluetooth standard is considered to be particularly advantageous. The corresponding short-range radio device has already been described in the German patent application 199 21 533.2 described at the beginning, from the patent applicant.

In the communications system according to the invention there is, in particular, provision that an authorization for call diversion from the external mobile radio device to the communications device in the vehicle is stored within the cellular mobile radio system. Such storage is necessary only once and then permits automatic activation of the call diversion.

In one particular embodiment of the invention there is provision that only services of the cellular mobile radio system which relate to the operation of the motor vehicle can be activated by means of the subscriber identification module (SIM card) of the communications device. This provides easy disconnection and connection of person-related and vehicle-related services and functions for telematics services, telecommunications services and telemetry services. This is particularly advantageous in vehicles which are used by different drivers as is frequently the case in particular with hire cars, company cars or the like.

Furthermore, there is provision in particular that when call diversion from the mobile radio device to the communications device of the vehicle is activated, it is possible to route calls via the mobile radio device. The mobile radio link within the mobile phone network is made here by means of the components of the communications device in the vehicle, a call transfer taking place from the communications device of the vehicle to the mobile radio device via the short-range radio link. As a result it is possible, for example, for the telephone call also to be made by a passenger at the rear of the vehicle who has no access to the hands-free device of the communications device.

The call diversion is preferably automatically deactivated if the mobile telephone leaves the range of the short-range radio link. This ensures that even when the driver leaves the vehicle he can be reached again by means of his mobile radio device without special operating steps being necessary for this purpose.

The communications system can, in particular, also be configured for interaction with more than one mobile radio device. This has the advantage that even when there are a plurality of passengers in the vehicle, improved functionality, for example by using the antenna of the communications device is achieved while at the same time each of the passengers can make a call from his mobile radio device and the billing of the call charges is also carried out by means of the subscriber identification of the respective mobile radio device.

A method according to the invention for setting up an interactive call diversion is not restricted exclusively to the combination between a communications device of a vehicle and an external mobile radio device but rather can be applied generally with two or more mobile radio devices. A method according to the invention for setting up an interactive call diversion between a first and a second mobile radio device of a cellular mobile radio system, which each have a short-range radio device is therefore characterized by the method steps:

data is exchanged between the first and the second mobile radio device when the second mobile radio device enters the range of the short-range radio device of the first mobile radio device,

the second mobile radio device is identified and authorized by means of the data which is exchanged over the short-range radio link,

a call diversion is set up from the second mobile radio device to the first mobile radio device within a mobile radio system of the mobile radio device. In particular, with such a method it is also tested whether an authorization for a call diversion from the second mobile radio device to the first mobile radio device is registered within the cellular mobile radio system.

There is preferably provision that, when call diversion is activated from the second mobile radio device to the first mobile radio device, telephone calls or a data transfer can be carried out within the cellular mobile radio system via the first mobile radio device, the billing for the mobile radio link being carried out via the subscriber identification module of the second mobile radio device. As a result, it is possible, in particular, to use higher functionality or simpler operator control of the first mobile radio device while, however, the billing of calls is carried out via the second mobile radio device, as a result of which it is possible to separate out call charges.

In one particular embodiment of the invention there is provision for the first mobile radio device to perform a server function and for a call diversion to be possible between more than two mobile radio devices. The call diversion is always possible here from a plurality of mobile radio devices to the first mobile radio device with the server function. As a result, the functionality of a telephone system can be set up, outgoing calls always being transmitted into the mobile phone network via the first mobile radio device, but it being possible to assign the billing to the various mobile radio devices on a person-specific basis.

In particular, there is provision that a call transfer/acceptance can be carried out between the mobile radio devices. This ensures that a telephone call can be made to any mobile radio device which is involved In this method. Further advantageous refinements are given in the subclaims.

### BRIEF DESCRIPTION OF THE DRAWINGS

The invention will be explained in more detail below with reference to exemplary embodiments and the drawing, in which:

FIG. 1 shows a communications device according to the invention and the essential components of a communications system according to the invention,

FIG. 2 shows a first method sequence for the initial registration and simultaneous activation of a call diversion in the mobile phone network,

FIG. 3 shows a method sequence for diverting an in-coming telephone call,

FIG. 4 shows a method sequence for diverting a second mobile radio device,

FIG. 5 shows a method sequence for diverting an outgoing telephone call.

### DETAILED DESCRIPTION OF THE PREFERRED EMBODIMENTS

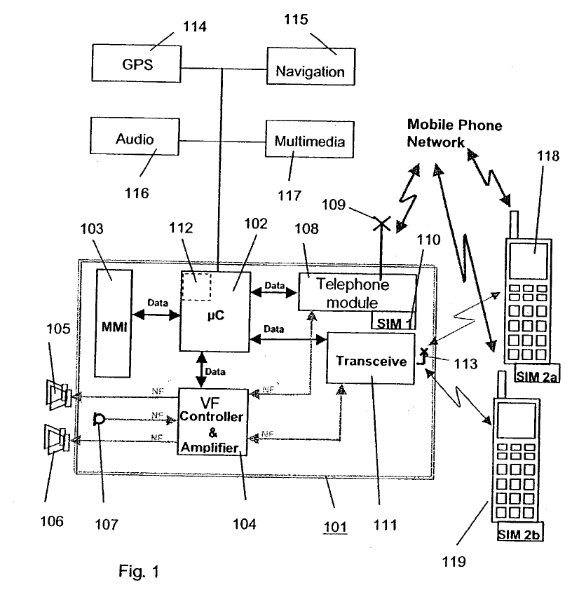

FIG. 1 illustrates, by way of example, a communications system according to the invention. The communications system contains a communications device 101 which is arranged in a vehicle. A central component of the communications device 101 is the control unit. 102. An input unit 103 is connected to the control unit 102. In addition, an audio output unit, which contains a VF controller and amplifier 104 as well as the loudspeakers 105, 106 which are connected to the VF controller 104. In addition, a microphone 107 is connected to the VF controller 104. The communications device 101 also contains a mobile radio module 108. The mobile radio module 108 contains the necessary components for setting up a radio link within a cellular mobile phone network, for example according to the GSM or the UTMS standard. A component of the mobile radio module here is in particular a transceiver device. The mobile radio module 108 is connected to an antenna 109 which is generally mounted on the outside of the vehicle in order to be able to set up a high-quality mobile radio link. Another component of the mobile radio module 108 is a subscriber identification module 110 which is embodied as an SIM card in a known fashion conventional mobile radio devices. With the described components, the communications device is configured for mobile radio traffic within a cellular mobile phone network. In particular, a hands-free device is implemented here by means of the microphone 107 and the loudspeakers 105, 106.

The communications device 101 then additionally contains a transceiver 111 which is known per se and which is configured as a short-range radio device, in particular according to the Bluetooth standard. The transceiver 111 is connected to a suitable transmission/reception antenna 112. In addition, the transceiver 111 is connected to the control device 102 so that data can be exchanged between these two components. Audio signals can be exchanged with the VF controller 104 via a link between the transceiver 111 and the VF controller 104.

The communications device 102 can optionally be connected to a GPS reception module 114 via an interface. In this case, the precise position of the vehicle can be determined so that said position can also be transmitted via the mobile phone network in the case of an outgoing emergency call or a request for help in the case of a breakdown. The communications device 101 then has the functionality of what is referred to as a telematics terminal.

In addition, the communications device 101 can be connected via an interface to a vehicle navigation system 115 which is known per se. In particular traffic-related data which has been received via the mobile radio link can be passed on to the navigation system via the communications device 101. In this way, what is referred to as dynamic navigation can be implemented.

Furthermore, the communications device 101 can be connected to an audio system 116 of the motor vehicle. In this case, the loudspeakers 105, 106 may also be, in particular, components of this audio system.

In a further refinement, the communications device 101 can be connected to a vehicle multimedia system 117 so that, for example, an Internet access can be implemented in the vehicle via the communications device 101.

At least one additional mobile radio device 118, 119 is a component of the communications system according to the invention. These mobile radio devices have, in a known fashion, a mobile radio module, a user interface and an antenna and can therefore be used independently of the communications system 101. The mobile radio devices 118, 119 are in this respect in particular commercially available mobile telephones. As is customary with these telephones, the mobile radio devices 118, 119 each have a SIM card via which it is possible to perform identification within the mobile phone network.

The mobile radio devices 118, 119 then additionally have a short-range radio device which corresponds essentially to the short-range radio device within the communications device 101. Corresponding short-range radio devices have also already been described in the German patent application 199 21 533.2 in conjunction with communications systems for motor vehicles. It is now possible to exchange data via the short-range radio devices of the communications device 101 and the mobile radio devices 118, 119. The data received by the mobile radio devices 118, 119 via the antenna 113 and the transceiver 111 is passed on here to the control unit 102. By means of a corresponding program, a comparison is made in the control unit 102 between the received mobile radio data and data which is stored in the storage device 112. The comparison is made here with respect to predefined features which relate in particular to a device identifier of the mobile radio devices 118, 119. If this comparison has a positive result, i.e. the mobile radio device 118, 119 is an authorized device, a mobile radio link is automatically made from the communications device 101 to the cellular mobile radio system. Within the scope of this mobile radio link, a status message is transmitted to a server of the mobile radio system, which server in particular activates a call diversion from the mobile radio terminal 118, 119 to the communications device 101. As a result it is possible for telephone calls directed to the mobile radio devices 118, 119 to be transferred to the communications device 101 via a mobile radio link within the cellular mobile phone network, while the billing of call charges which may be incurred is, however, carried out by means of the SIM card of the mobile radio device 118, 119.

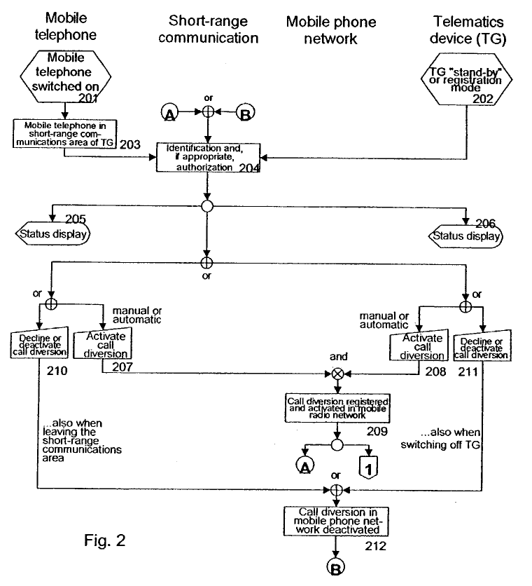

Various methods for situations which occur in different ways for a communications system with a telematics device (TG) as communications device in the vehicle and one or more mobile telephones as mobile radio devices are described below with reference to FIGS. 2 to 5.

FIG. 2 shows a method sequence for the initial registration and activation of a call diversion, i.e. an example of a method sequence which occurs when a mobile telephone 118, 119 first enters the short-range radio reception area of a communications device 101. As is also the case in the following method examples, the individual method steps which take place within the mobile telephone, via the short-range communication, the mobile phone network and within the communications device in the vehicle are represented in different columns.

In the initial situation according to FIG. 2, the mobile telephone is switched on in step 201 and the communications device, which is a telematics terminal TG, is in a registration mode (step 202). The registration mode can be set, for example, in a menu and it permits the initial registration of new communications devices.

In step 203 the mobile telephone is then in the short-range communications area of the telematics device TG. The short-range communications device is one which operates according to what is referred to as the Bluetooth method, which is known per se. In method step 204, mutual identification of the telematics device and of the mobile telephone is carried out. After the termination of step 204, it is detected in the present case that the mobile telephone is located for the first time in the short-range communications area of the telematics device TG. In steps 205 and 206, a corresponding status display is provided both on the mobile telephone and on the telematics device. The status display may be, for example, an icon which appears on the respective display of the mobile telephone and of the telematics device and which symbolizes to the user that a new device is located in the short-range radio reception area.

The user can then cause the newly identified mobile telephone to be authorized for use in a communications system together with the telematics device and cause a call diversion to be registered and activated in the mobile radio system. This can be carried out both at the mobile telephone, in step 207, and at the telematics device, in step 208. For this purpose, for example, a corresponding key is to be activated on the mobile telephone or on the telematics device, after which a mobile radio link is automatically set up into the mobile phone network in step 209 and a corresponding call diversion message is transmitted to the network operator. Alternatively, the call diversion in the method steps 210, 211 can however also be rejected either at the mobile telephone or at the telematics device. The rejection can, for example, also be carried out by activating a corresponding key. However, in one alternative embodiment, the rejection can also take place in a timed fashion so that after a predefined time period, after which the mobile telephone has entered the short-range communications area of the telematics device without a call diversion having being activated, said call diversion is considered to have been rejected. In a modified method of operation in which a call diversion was already activated in the mobile phone network, such a call diversion can also be deactivated in the method steps 210 and 211, the corresponding message being transmitted to a server of the mobile radio operator via the mobile phone network in the method step 212. Method steps 209, 212 can then be followed again by an identification and authorization step 204 so that a call diversion can be activated or deactivated at any time. This can also be possible, in particular, in the standby mode of the telematics device.

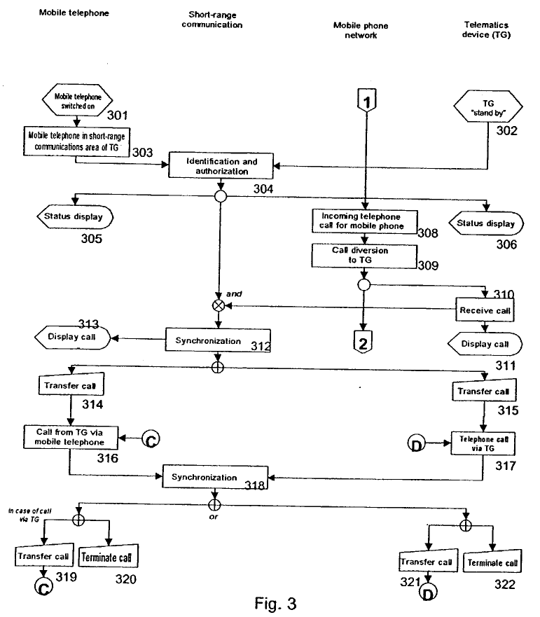

FIG. 3 shows a method sequence in the case of an incoming telephone call at the mobile telephone. The method steps 301-306 are largely identical to the method steps 201-206. In it we assumed that the call diversion is activated in the mobile phone network for the mobile telephone. This is designated by the connection point designated by “1”, which is identical to the corresponding connection point according to FIG. 2. In step 308, a telephone call for the mobile telephone is then received in the mobile phone network.

In step 309, a call diversion to the telematics device is carried out within the mobile phone network. The incoming call is then received in the telematics device in method step 310, after which a call display is carried out in the telematics device in step 311. The telematics device then transmits to the mobile telephone, via the short-range communications link, a signal which indicates the incoming call. For this purpose, in method step 312 a synchronization is carried out within the short-range communication so that it is then also possible to display an indication of the incoming call on a display of the mobile telephone in method step 313. The call can then be transferred to the mobile telephone in method step 314, or to the telematics device in method step 315.

If the call is transferred to the mobile telephone in step 314, the call is then made via the mobile telephone in step 316. If, on the other hand, the call is transferred to the telematics device in step 315, the telephone call is then made via the hands-free device of the telematics device in step 317. Regardless of which of the devices is used to make the call, synchronization between the mobile telephone and the telematics device is in turn carried out via the short-range communications interface in step 318. As a result it is possible to transfer the call at any time, even to the device which is not being used for the call at that particular time. If, for example, the telephone call is made via the telematics device, the call can be transferred to the mobile telephone in step 319 by pressing a corresponding key, or terminated in step 320. In the same way, when a call is being made via the mobile telephone in step 316, the call can also be transferred to the telematics device in step 321 or terminated at the telematics device in step 322. If the call is transferred to the mobile telephone in step 319, it can subsequently be routed to the mobile telephone in step 316, while the call routing is carried out in a corresponding way in step 317 when the call is transferred to the telematics device in step 321. This is symbolized by the connection points C and D, respectively.

In the methods described, the call is thus always received via a mobile radio link to the telematics device, as a result of which in particular an antenna of the telematics device which is mounted on the vehicle can be used. The call itself can also be made at the mobile telephone. In the latter case, the roaming is also carried out via the short-range communications device.

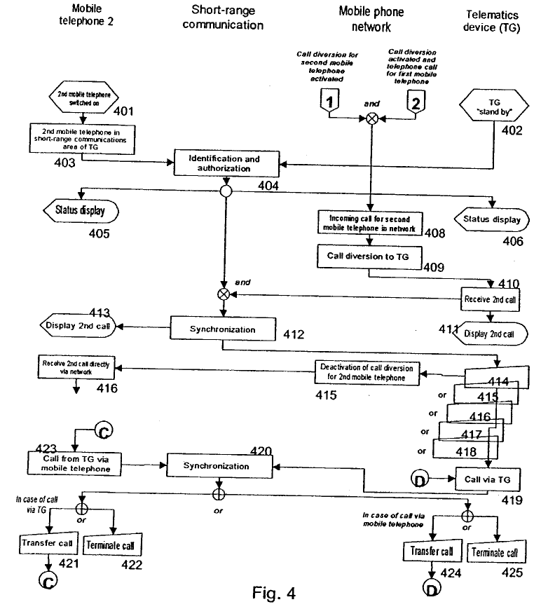

FIG. 4 illustrates, as a further exemplary embodiment, a method sequence in which two mobile telephones are connected to the telematics device by means of a call diversion. A telephone call is already being made via the first mobile radio device, while a telephone call for the second mobile radio device is simultaneously received at the telematics device. In terms of the first telephone call, the method follows the method designated in FIG. 3 at the connection point designated by 2, within the mobile phone network. For the second mobile telephone, a call diversion is also activated in the network so that, in terms of the mobile phone network, a connection is made here to the method according to FIG. 2 at the connection point designated by 1.

The method steps 401-406 correspond to the method steps 301-306 with the difference that they now relate to the second mobile telephone. Taking the described initial situation as a starting point, in step 408 a call for the second mobile telephone is then received in the mobile phone network. In a way which is analogous to the method already described in conjunction with FIG. 3, this call is received (step 410) at the telematics device owing to the call diversion, and in step 411 this call is displayed at the telematics device. In a way analogous to step 312, in step 412 synchronization takes place and the incoming telephone call is subsequently displayed, but now on the second mobile telephone (step 413).

Following the synchronization of the short-range communication in step 412, different functions can then be performed at the telematics device. Because a telephone call has already been made via the telematics device, there are different possibilities for this, which are described below. For example, in step 414 the telephone call is passed on to the second mobile telephone, and in step 415 this results in an automatic deactivation of the call diversion for the second mobile telephone within the mobile phone network. Then, in step 416 the second call can be received directly at the second mobile telephone via the mobile phone network, and a normal mobile telephone call takes place.

However, as an alternative to the forwarding of the second call to the mobile telephone in step 414, the second telephone call can also be transferred in step 415 or traded (step 416) or the second call can be declined (step 417) or a call conference with both telephone calls can be activated (step 418). In these cases, the second call is made via the telematics device (step 419), and then in step 420 there is in turn synchronization via the short-range radio link between the mobile telephone 2 and the telematics device. The call can then be transferred to the mobile telephone 2 in step 421 or terminated at the mobile telephone 2 in step 422. If the call in step 421 is transferred to the mobile telephone 2, the call is then made via the second mobile telephone in step 423. Here, synchronization between the mobile telephone and telematics device takes place in turn in step 420.

If the call is made via the second mobile telephone, the call can finally be transferred to the telematics device again in step 424 and subsequently routed via the telematics device in step 419. This is indicated by the connection point D. Alternatively, the call can be terminated by means of the telematics device in step 425.

The functions described above are essentially stored, and can be executed, essentially in the form of a program in the telematics device. In the call diversion methods described, all the call charges which may be incurred for the call for the second mobile telephone are also assigned to its SIM card, regardless of whether the call is routed via the second mobile telephone or the telematics device.

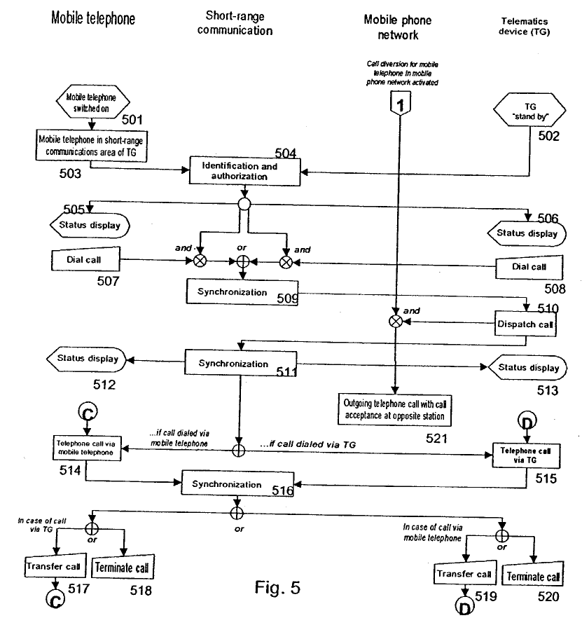

FIG. 5 illustrates a method sequence which now applies to an outgoing telephone call. As is apparent from the connection point which is designated by 1 and joins on to FIG. 1, the call diversion for the mobile telephone is activated in the mobile phone network. The method steps 501-506 correspond in turn to the method steps 301-306 and 401-406, respectively. After identification and authorization of the mobile telephone and of the telematics device in step 504, a call can be dialed to the mobile telephone or to the telematics device in step 507 or 508. After the call has been dialed, synchronization of the short-range communication between the mobile telephone and the telematics device takes place in turn in step 509. Then, in step 510 the call is dispatched to the telematics device, after which an outgoing telephone call, which can be accepted at the opposite station, is made within the mobile telephone network in step 521.

Following step 510, there is in turn, in parallel with step 521, synchronization of the short-range radio link in step 511. There is then the corresponding status display 512 or 513 on the mobile telephone or on the telematics device, respectively.

If the call was dialed at the mobile telephone, the telephone call is made via the mobile telephone in step 514. If the call was dialed via the telematics device, the telephone call is made via the hands-free device of the telematics device in step 515.

In both cases, synchronization is carried out over the short-range radio link in step 516. If the telephone call is made via the telematics device in step 515, the telephone call can also be transferred to the mobile telephone in step 517 and subsequently continued in step 514. This is characterized by the connection point C. The call can then also be terminated at the mobile telephone in step 518. If, on the other hand, the call is made via the mobile telephone, the call can be transferred to the telematics device in step 519 and then made in step 515. This is symbolized by the connection point D. In this case, the call can be terminated at the telematics device in step 520.

Thus, when the call diversion is switched on, the mobile radio link is set up via the telematics device even for an outgoing telephone call, but there is a cost assignment of the telephone call to the SIM card of the mobile telephone owing to the activated call diversion. The actual call can thus be routed either to the mobile telephone or to the telematics device. The switching over of the routing of the call is always carried out here, as also in the preceding examples, via the short-range radio link between the mobile telephone and the telematics device, whereas a mobile radio link is always set up from the telematics device to the mobile phone network.

When two mobile telephones are operated by means of call diversion to a telematics device, further situations may occur which will be explained briefly below. In all cases it is assumed that a call diversion is activated from both mobile telephones to the telematics device.

The next example relates to a situation in this respect in which a telephone call is being made with the first mobile telephone and an outgoing telephone call is to be made at the second mobile telephone. The first telephone call can be routed via the telematics device or the first mobile telephone. The second telephone call is then dialed with the second mobile telephone. However, because a mobile radio link has already been set up from the telematics device to the mobile phone network, the second mobile radio call can be made only directly from the second mobile radio device. For this purpose, the call diversion is automatically deactivated. The call charges are assigned to the respective mobile radio telephones.

In a further exemplary embodiment it is assumed that a telephone call is made when the call diversion is switched on, while at the same time telematics data is being transmitted. The telephone call can be routed via the telematics device or via the mobile telephone, while at the same time telematics data, for example diagnostics data or traffic data, is transmitted. Parallel call traffic and data traffic is thus possible. The billing of the telematics charges is carried out here via the SIM card of the telematics device, while the billing for the call is carried out via the SIM card of the mobile telephone.

With the method according to the invention and the communications system according to the invention, comfortable communication is possible within a motor vehicle using a hands-free device which is integrated in the motor vehicle, it being possible at the same time to assign the charges for various services to the vehicle or to a user-specific terminal. This is implemented in particular by means of an automatic call diversion within the cellular mobile radio system and a short-range communication between the terminals. For this purpose, a plurality of specific embodiments, in addition to the embodiments described, are possible.

What is claimed is:

1. The communications device of a motor vehicle comprising an input unit and an audio output unit which are connected to a control unit, and a mobile radio module, connected to the control unit, of a cellular mobile radio system, wherein the communications device has a short-range radio device which is connected to the control unit, the short-range radio device being configured to exchange data over a short-range radio link, the communications device having a comparator module for comparing data received over the short-range radio link with data stored in a storage element, and it being possible to automatically set up a mobile radio link for transferring a status message within the mobile radio system when received and stored data correspond in terms of predefined features.

2. The communications device as claimed in claim 1, wherein the status message relates to a call diversion within the mobile radio system.

3. The communications device as claimed in claim 1, wherein the communications device contains a hands-free device.

4. The communications device as claimed in claim 1, wherein the communications device is a component of an audio system, of a multimedia system, of a telematics system or of a navigation system.

5. The communications device as claimed in claim 1, wherein the cellular mobile radio system is a system according to the GSM or UMTS standard.

6. The communications device as claimed in claim 1, wherein the short-range radio link is not more than 100 m, preferably not more than 10 m.

7. The communications device as claimed in claim 1, wherein the short-range radio device operates according to the Bluetooth standard.

8. A communications system comprising a communications device which is integrated in a motor vehicle and has an input unit and an audio output unit which are connected to a control unit, and a mobile radio module, connected to the control unit, of a cellular mobile radio system, and a short-range radio device which is connected to the control unit, and an external mobile radio device of a cellular mobile ratio system with a second short-range radio device, the short-range radio devices being configured to exchange data over a short-range radio link, the communications device comprising a comparator module for comparing data received from the mobile radio device over the short-range radio link with data stored in a storage element of the communication device, and it being possible to automatically set up a mobile radio link for transferring a status message within the mobile radio system when received and stored data correspond in terms of predefined features.

9. The communications system as claimed in claim 8, wherein the status messages relates to a call diversion from the mobile radio device to the communications device.

10. The communications system as claimed in claim 8, wherein an authorization for the call diversion of the mobile radio device to the communications device is stored in the cellular mobile radio system.

11. The communications system as claimed in claim 8, wherein the communications device has a hands-free function.

12. The communications system as claimed in claim 8, wherein the cellular mobile radio system is a system according to the GSM or UMTS standard.

13. The communications system as claimed in claim 8, wherein the range of the short-range radio link is not more than 100 m, preferably not more than 10 m.

14. The communications system as claimed in claim 8, wherein short-range radio device operates according to the Bluetooth standard.

15. The communications system as claimed in claim 8, wherein the predefined features are a device identifier of the mobile radio device.

16. The communications system as claimed in claim 8, wherein the communications device contains a chip card as a subscriber identification module for the cellular mobile radio system.

17. The communications system as claimed in claim 8, wherein the mobile radio device contains a chip card as a subscriber identification module for the cellular mobile radio system.

18. The communications system as claimed in claim 8, wherein only services of the cellular mobile radio system which relate to the operation of the motor vehicle can be activated by means of the subscriber identification module of the communications device.

19. The communications system as claimed in claim 8, wherein when the call diversion for the mobile radio device is activated, telephone calls or a data transfer can be carried out by means of the communications device and are billed by means of the subscriber identification module of the mobile radio device.

20. The communications system as claimed in claim 8, wherein even when the call diversion from the mobile radio device to the communications device is activated, it is possible to make a call via the mobile radio device, a call transfer being made via the short-range radio link.

21. The communications system as claimed in claim 8, wherein the call diversion is deactivated automatically if the mobile radio device leaves the range of the short-range radio link.

22. The communications system as claimed in claim 8, wherein it contains more than one mobile radio device.

23. A method for setting up an interactive call diversion between a first and a second mobile radio device of a cellular mobile radio system, which each have a short-range radio device, comprising the method steps:
data is exchanged between the first and the second mobile radio device when the second mobile radio device enters the range of the short-range radio link of the first mobile radio device,
the second mobile radio device is identified and authorized by means of the data which is exchanged via the short-range radio link,
a call diversion is set up from the second mobile radio device to the first mobile radio device within a mobile radio system of the mobile radio device.

24. The method as claimed in claim 23, wherein it is tested whether an authorization for a call diversion from the second mobile radio device to the first mobile radio device is registered within the cellular mobile radio system.

25. The method as claimed in claim 23, wherein authorization for a call diversion from the second mobile radio device to the first mobile radio device is stored once within the cellular mobile radio system.

26. The method as claimed in claim 23, wherein the cellular mobile radio system is a system according to the GSM or UMTS standard.

27. The method as claimed in claim 23, wherein the short-range radio device is operated according to the Bluetooth standard.

28. The method as claimed in claim 23, wherein the mobile radio device is contained in a subscriber identification module.

29. The method as claimed in claim 23, wherein when the call diversion from the second mobile radio device to the first mobile radio device is activated, telephone calls or a data transfer can be carried out within the cellular mobile radio system via the first mobile radio device, the billing for the mobile radio link being carried out by means of the subscriber identification module of the second mobile radio device.

30. The method as claimed in claim 23, wherein even when the call diversion from the second mobile radio device to the first mobile radio device is activated, it is possible to make a call within the cellular mobile radio system, the mobile radio link being set up from the first mobile radio device and a call transfer being made between the first and the second mobile radio device via the short-range radio link.

31. The method as claimed in claim 23, wherein the call diversion is deactivated automatically if a short-range radio link can no longer be set up between the first and the second mobile radio device.

32. The method as claimed in claim 23, wherein the first mobile radio device performs a server function and a call diversion between more than two mobile radio devices is made possible.

33. The method as claimed in claim 23, wherein a call transfer can be carried out between the mobile radio devices.

34. The method as claimed in claim 23, wherein the first mobile radio device is a component of a telematics device of a motor vehicle.

35. The method as claimed in claim 23, wherein the first mobile radio device contains a hands-free function.
